(19) United States
(12) Patent Application Publication
(10) Pub. No.: US 2024/0377800 A1
(43) Pub. Date: Nov. 14, 2024

(54) ENERGY CONSUMPTION PREDICTION BASED ON ENVIRONMENTAL STATE

(71) Applicant: WESCO Distribution, Inc., Pittsburgh, PA (US)

(72) Inventors: Kishor Saitwal, Sugar Land, TX (US); Shashi Bhushan Dande, Spring, TX (US); Avinash Wesley, New Caney, TX (US); Rafael Da Matta Navarro, Houston, TX (US); Raja Vikram Raj Pandya, Katy, TX (US); Shivani Arora, Houston, TX (US); Merwan Mereby, Baton Rouge, LA (US); Ashok Ramesh Bajaj, Katy, TX (US); Akash Khurana, Houston, TX (US)

(73) Assignee: WESCO Distribution, Inc., Pittsburgh, PA (US)

(21) Appl. No.: 18/195,663

(22) Filed: May 10, 2023

(51) Int. Cl. G05B 19/042

(52) U.S. Cl. CPC G05B 19/0428; G05B 2219/2639

(57) ABSTRACT

Aspects of the subject technology relate to systems, methods, and computer-readable media for predicting energy states of devices operating in an environment. An operational constraint and a device setting for a device operating in an environment can be identified. An environmental state of the environment can be predicted based on the device operating at the device setting and under the operational constraint through application of an environmental state model that maps varying operational constraints and varying device settings to varying environmental states in the environment. An energy state for operating the device in the environment at the device setting and under the operational constraint can be predicted based on the predicted environmental state through application of an energy consumption model that maps the varying environmental states to varying energy states.

### TECHNICAL FIELD

The present technology pertains to predicting energy states of devices operating in an environment, and more particularly, to predicting energy states of the devices based on predicted environmental states in the environment.

### BACKGROUND

In an environment, e.g. a warehouse, many devices are operated to perform various functions in the environment. Such devices can be operated based on constraints that are defined in relation to the environment. For example, a constraint can include that an environment needs to be maintained within a specific temperature range during the day when the devices are operated in the environment. Further, such devices can also be capable of operating at different device settings. The different device settings at which the devices are operated can contribute to the operational constraints being met in the environment. However, such device settings, while contributing to the meeting of the operational constraints, can have varying effects on the energy consumption of the devices. For example, a device can be operated at either a first device setting or a second device setting while still meeting an operational constrain in the environment. Further, the first device setting can consume more power than the second device, e.g. not be optimized for device operation from an energy perspective, making it more beneficial for controlling operation of the device in the environment.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

FIG. 1, illustrates a representation of an environment in which energy consumption can be predicted for devices, in accordance with various aspects of the subject technology.

FIG. 2 illustrates an example state transition diagram for predicting energy states of a devices based on environmental states, in accordance with various aspects of the subject technology.

FIG. 3 illustrates a flowchart for an example method of predicting an energy state of a device based on environmental state, in accordance with various aspects of the subject technology.

FIG. 4 is a schematic representation of a flow for processing data to identify characterize an environmental state in an environment, in accordance with various aspects of the subject technology.

FIG. 5 is a schematic representation of a flow for evaluating device impact on both an environmental state and energy consumption for mapping user settings to environmental state and energy state, in accordance with various aspects of the subject technology.

FIG. 6 is a schematic representation of a flow for evaluating the effect of user settings on environmental states, in accordance with various aspects of the subject technology.

FIG. 7A illustrates a user interface displaying temperature ranges that serve as operational constraints, in accordance with various aspects of the subject technology.

FIG. 7B illustrates a user interface displaying time intervals that serve as either or both device settings and operational constraints, in accordance with various aspects of the subject technology.

FIG. 7C illustrates a user interface displaying specific settings related to operation of lights, in accordance with various aspects of the subject technology.

FIG. 7D illustrates a user interface displaying charging times for charging devices in an environment, in accordance with various aspects of the subject technology.

FIG. 7E illustrates a user interface displaying tunning times for running devices in an environment, in accordance with various aspects of the subject technology.

FIG. 8A illustrates a user interface displaying energy usage on a per-device basis

FIG. 8B illustrates a user interface displaying energy usage on different times of day, in accordance with various aspects of the subject technology.

FIG. 9 shows a graph of energy consumption over time for default user settings and energy consumption over time for predicted user settings, in accordance with various aspects of the subject technology.

FIG. 10 illustrates a schematic representation of an example of a deep learning neural network, in accordance with various aspects of the subject technology.

FIG. 11 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

As discussed previously, in an environment, e.g. a warehouse, many devices are operated to perform various functions in the environment. Such devices can be operated based on constraints that are defined in relation to the environment. For example, a constraint can include that an environment needs to be maintained within a specific temperature range during the day when the devices are operated in the environment. Further, such devices can also be capable of operating at different device settings. The different device settings at which the devices are operated can contribute to the operational constraints being met in the environment. However, such device settings, while contributing to the meeting of the operational constraints, can have varying effects on the energy consumption of the devices. For example, a device can be operated at either a first device setting or a second device setting while still meeting an operational constrain in the environment. Further, the first device setting can consume more power than the second device, e.g. not be optimized for device operation from an energy perspective, making it more beneficial for controlling operation of the device in the environment.

However it is difficult to accurately predict the energy demands of devices in an environment. In particular, it is difficult to predict how much energy a device will consume in meeting specific constraints that are defined in relation to the environment. For example, it is difficult to predict how much energy an air conditioning system will use in cooling a warehouse to a specific temperature during summer.

There is therefore a need for systems and methods of predicting an energy state for a device based on a device setting for the device. Specifically, there exists a need for systems and methods of predicting an energy state for a device based on a constraint associated with operation of the device in an environment.

The disclosed technology addresses the foregoing by predicting an energy state of a device operating under a specific operational constraint and at a specific device setting based on an environmental state in an environment in which the device is operating.

In various embodiments, a method can include identifying an operational constraint for a device in an environment. Further, a device setting for the device operating in the environment can be selected. The method can also include predicting an environmental state of the environment based on the device operating at the device setting and under the operational constraint through application of an environmental state model that maps varying operational constraints and varying device settings to varying environmental states in the environment. Additionally, an energy state for operating the device in the environment at the device setting and under the operational constraint can be predicted based on the predicted environmental state through application of an energy consumption model that maps the varying environmental states to varying energy states.

In various embodiments, a system can include one or more processors and at least one computer-readable storage medium having stored therein instructions which, when executed by the one or more processors, cause the one or more processors to identify an operational constraint for a device in an environment. The instructions can also cause the one or more processors to select a device setting for the device operating in the environment. Further, the instructions can cause the one or more processors to predict an environmental state of the environment based on the device operating at the device setting and under the operational constraint through application of an environmental state model that maps varying operational constraints and varying device settings to varying environmental states in the environment. Additionally, the instructions can cause the one or more processors to predict an energy state for operating the device in the environment at the device setting and under the operational constraint based on the predicted environmental state through application of an energy consumption model that maps the varying environmental states to varying energy states.

In various embodiments, non-transitory computer-readable storage medium has stored therein instructions which, when executed by one or more processors, can cause the one or more processors to identify an operational constraint for a device in an environment. The instructions can also cause the one or more processors to select a device setting for the device operating in the environment. Further, the instructions can cause the one or more processors to predict an environmental state of the environment based on the device operating at the device setting and under the operational constraint through application of an environmental state model that maps varying operational constraints and varying device settings to varying environmental states in the environment. Additionally, the instructions can cause the one or more processors to predict an energy state for operating the device in the environment at the device setting and under the operational constraint based on the predicted environmental state through application of an energy consumption model that maps the varying environmental states to varying energy states.

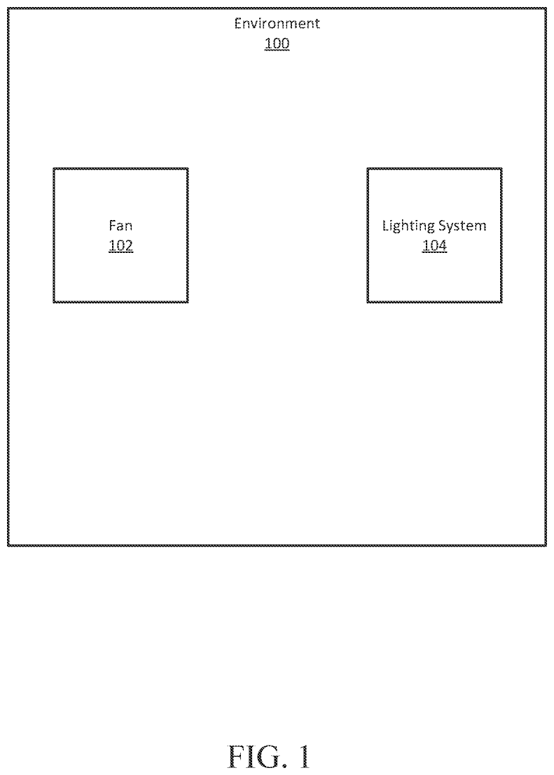

The disclosure now turns to a description of FIG. 1, which illustrates a representation of an environment 100 for which the systems and methods described herein can be implemented. Specifically, FIG. 1 illustrates an environment 100 with devices that can have energy states predicted for different device settings based on environmental states in the environment 100. More specifically, the environment 100 includes a fan 102 and a lighting system 104. While only two devices, or otherwise systems, are shown in the environment 100, the technology described herein can be implemented in an environment with more or fewer devices. The environment 100 can be an enclosed environment 100. For example, the environment 100 can be formed in a warehouse or other type of building.

The devices, e.g. the fan 102 and the lighting system 104, can include applicable devices that are capable of operating in the environment 100. Specifically, the devices can include applicable devices that affect the environment 100 through operation in the environment 100. In affecting the environment 100, the devices can affect an environmental state of all or a portion of the environment 100. An environmental state of an environment, as used herein, can include values of environmental parameters/variables that characterize the environment 100. For example, an environmental state can be defined by a temperature and a humidity level. Further, an environmental state can include temporal characteristics in relation to an environment. For example, an environmental state can include a temperature in a warehouse when people are at the warehouse during the day.

Environmental states of the environment 100 can be measured through applicable sensors that are capable of measuring or quantifying environmental parameters that characterize the environment 100. Specifically, environmental states of the environment 100 can be measured by sensors that are in the environment 100. For example, the temperature and humidity in the environment 100 can be measured by sensors that are disposed in the environment. Further, the environmental states of the environment 100 can be determined from data that is external to or otherwise generated separately from the environment 100. For example, an environmental state indicating the number of people who will be present in a warehouse during the day can be determined from an employee schedule that is maintained separate from, or otherwise, not on premise at the warehouse.

Operation of the devices in the environment 100 can be controlled according to different device settings for the devices. Device settings, as uses herein, are defined by operational parameters that control how a device operates within an environment. Specifically, different device settings can have different values of operational parameters which cause a device to operate differently under the different device settings. For example, the lighting system 104 can have device settings that correspond to a normal light output and device settings that correspond to a reduced light output. In particular, a device setting for the reduced light output can include operating at reduced electrical current or voltage levels in comparison to a device setting for the normal light output. Device settings can affect the environment 100, e.g. by controlling how a device operates in the environment 100. For example, a device setting that controls the fan 102 to operate at a higher speed can affect the environment 100 by dropping the temperature in the environment 100.

Device settings for the devices, as will be discussed in greater detail later, can be predicted for the devices based on environmental states in the environment 100. Specifically, device settings for the devices in operating with respect to operational constraints can be predicted for the devices based on environmental states in the environment 100. Operational constraints, as used herein, can include desired characteristics of operation of a device and desired environmental characteristics of the environment 100. For example, operational constraints can specify a desired temperature to be maintained in a warehouse during the day. In another example, operational constrains can specify that an electronic forklift should be charged during a specific time in the day.

Both operational constraints and device settings can be labeled, e.g. for purposes of this disclosure, as user settings. Specifically, operational constraints and device settings can be user-defined or otherwise associated with a user. Further, as both operational constraints and device settings can affect the environment 100, an environmental state of the environment 100 can be defined in relation to specific operational constraints and specific device settings. As follows, specific operational constraints and specific device settings can be mapped to specific environmental states. For example, the fan 102 and the lighting system 104 operating at specific output levels can cause a specific temperature and humidity level in the environment. As a result, an environmental state that defines the specific temperature and humidity level can be mapped to operation of the fan 102 and the lighting system 104 at the specific output levels. In another example, the fan 102 and the lighting system 104 can operate at specific output levels to maintain a desired temperature in the environment 100. However, a temperature that exceeds the desired temperature can be created in the environment 100 when the fan 102 and the lighting system 104 operate at the specific output levels. As follows, an environmental state that is defined by the temperature that exceeds the desired temperature in the environment 100 can be mapped to operation of the devices at the specific output levels in attempting to maintain the desired temperature. As will be discussed in greater detail later, this mapping or relation between different devices settings, different operational constraints, and different environmental states can be used in predicting energy states of devices operating at the different settings and under the different operational constraints in an environment.

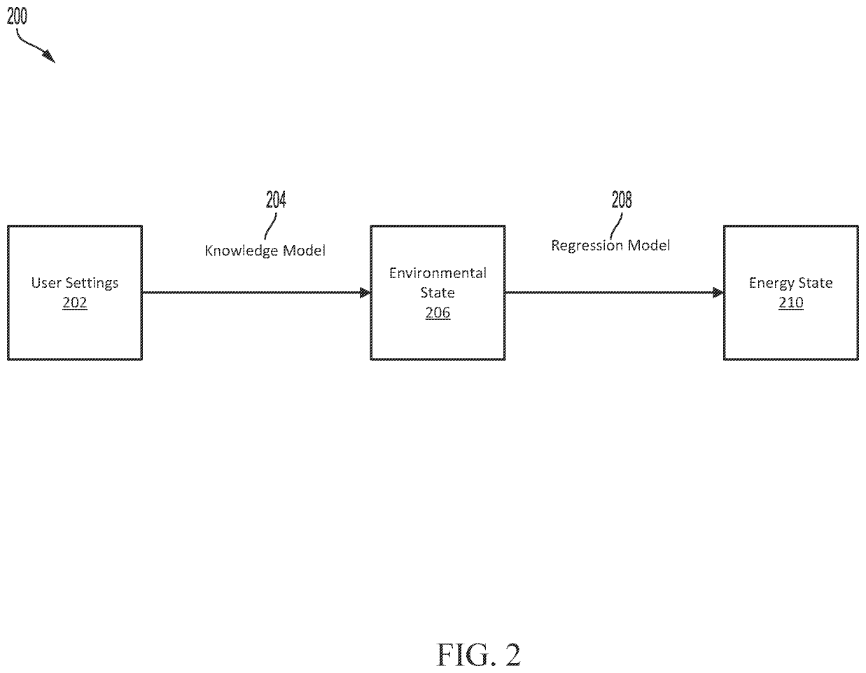

The disclosure now continues with a discussion of systems and methods for predicting an energy state of a device based on environmental states. Specifically, FIG. 2 illustrates an example state transition diagram 200 for predicting energy states of a devices based on environmental states. In the state transition diagram 200, a user setting state 202 is identified. The user settings in the user setting state 202 can include device settings that are identified or selected for a specific device. For example, the user settings can include that an air condition system should operate at a specific level in a warehouse during the day. Further, the user settings in the user setting state 202 can include operational constraints that are identified or selected. For example, the user settings can include the operational constraint that an air conditioning system should maintain a temperature in a warehouse beneath 70 degrees.

Next, an environmental state 206 corresponding to the user settings in the user settings state 202 is identified through application of a knowledge model 204. While the state transition diagram 200 shows the use of a knowledge model 204 to identify the environmental state 206 from the user settings state 202, an applicable environmental state model can be applied to identify the environmental state 206. Specifically, an applicable environmental state model that maps varying operational constraints and varying device settings to varying environmental states can be applied to identify the environmental state 206 from the user settings state 202.

After the environmental state 206 is identified, an energy state 210 for a device is identified based on the environmental state 206. In particular, an energy state 210 for a device operating according to the user settings in the user settings state 202 can be identified based on the environmental state 206 that is identified from the user settings state 202. An energy state, as used herein, can describe energy utilization characteristics of a device that is operating in a specific environment according to specific user settings. For example, an energy state 210 can specify that an air conditioning system operating in a warehouse during the summer will consume a certain amount of energy per hour in maintaining a specific temperature in the warehouse.

The energy state 210 can be identified based on the environmental state through application of a regression model 208. While the state transition diagram 200 shows the use of a regression model 208 to identify the energy state 210 from the environmental state 206, an applicable energy consumption model can be applied to identify the energy state 210. Specifically, an applicable energy consumption model that maps varying environmental states to varying energy states can be applied to identify the energy state 210 from the environmental state 206.

Both the knowledge model 204 and the regression model 208 can be trained through applicable techniques, such as the techniques described herein. More specifically, historical data can be used to extract an environmental state of a space, e.g. during a specific period of time. As follows, the regression model 208 can be trained using this environmental state as its input and a corresponding energy consumption of one or more devices as output. The energy consumption of the one or more devices, for purposes of training a model, can be identified through an applicable technique for measuring a device's energy consumption. For example, sensors in a power distribution system in an environment can be used in monitoring energy consumption of different devices in the environment. With respect to the knowledge model 204, different attributes within the extracted environmental state can be analyzed to understand the correlation amongst themselves for specific user settings. In turn, specific user settings can be mapped to specific environmental states, and the knowledge model 204 can be trained based on these mappings.

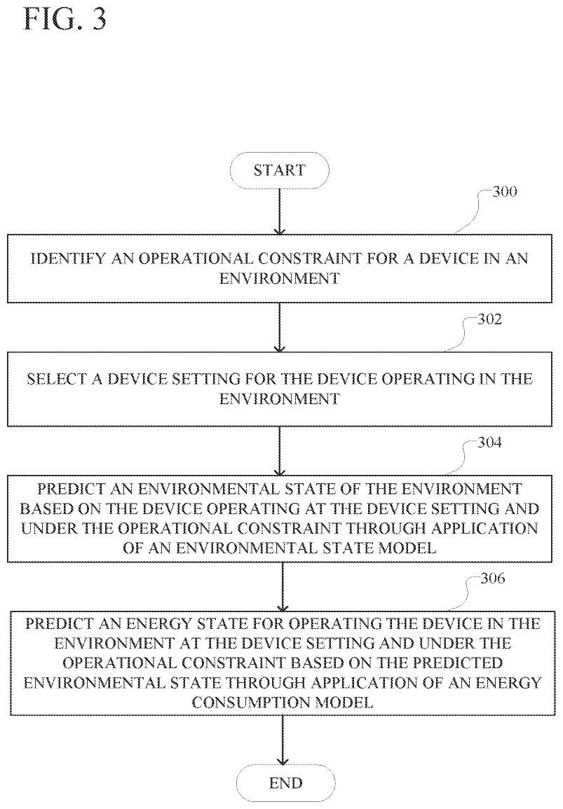

FIG. 3 illustrates a flowchart for an example method of predicting an energy state of a device based on environmental state. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method.

At step 300, an operational constraint for a device in an environment is identified. The operational constrain can be a user-defined constraint. Further, the operational constraint can be defined based on operation of a specific device in the environment. Additionally, the operational constraint can be defined based on a temporal aspect in association with operation of a device in an environment.

At step 302, a device setting for the device operating in the environment is selected. The device setting can be a user-defined setting for operating the device in the environment. Further, the device setting can be defined based on operation of the specific device in the environment. Alternatively, the device setting can be defined based on operation of a group of devices, potentially a group including the specific device, in the environment. Further, the device setting can be defined based on a temporal aspect in association with operation of the device in the environment.

The device setting can be defined based on operation of the device in the environment according to the operational constraint. Specifically, the device setting can be defined for the device, in operation, meeting the operational constraint. For example, the device setting can include operating a recharger for a forklift at night if an operational constraint specifies recharging the forklift at night.

At step 304, an environmental state of the environment is predicted based on the device operating at the device setting and under the operational constraint. In particular, the environmental state can be predicted based on application of an environmental state model that maps varying device setting and varying operational constraints to varying environmental states. The environmental state can be predicted for the device setting and the operational constraint based on the previously described relationship of both device settings and operational constrains affecting environmental states of an environment in which a device operates.

The environmental state model that is applied at step 304 can be trained based on historical data gathered for the environment. The historical data can include applicable data describing previously occurring characteristics of the environment. In particular, historical data can include data related to previous operation of devices in the environment. For example, historical data can include specific device settings of devices operating to meet specific operational constraints. Further, the historical data can include environmental states that are realized in the environment based on the operation of the devices in the environment. For example, the historical data can describe an environmental state in a warehouse at night when an air conditioning system is operating to maintain a specific temperature in the warehouse at night.

At step 306, an energy state for operating the device in the environment at the device setting and under the operational constraint is predicted based on the environmental state identified at step 304. In particular, the energy state can be predicted based on application of an energy consumption model that maps varying environmental states to varying energy states of devices. Predicting energy consumption/an energy state of a device based on an environmental state allows for prediction in an applicable future time period, e.g. any future time period. For example, energy consumption of a device operating in an environment can be forecasted a year or more in advance.

Further, energy states for multiple devices can be predicted from the same environmental state independently from each other. Specifically, the energy consumption model can be applied discretely and based on different devices to predict energy states for the different devices from the same environmental state. As will be discussed in greater detail later, the energy consumption model can be comprised of multiple regression techniques. As a result and when the energy consumption model is applied discretely in predicting energy states of different devices, the multiple regression techniques can be applied independent of each other to accurately predict the energy states for the different devices, e.g. from the same environmental state.

Additionally, the prediction of energy states through application of the energy consumption model can be made based on one or more environmental states at varying levels of granularity with respect to a number of devices in the environment. Specifically, energy states can be predicted at a group level, a zone level, or as previously described, an individual device level. For example, an energy state for a group of devices in the environment can be predicted for the entire group through application of the energy consumption model. In another example, an energy state for a zone of devices in the environment can be predicted for the entire zone of devices through application of the energy consumption model. In other example, an applicable grouping technique can be used to segment devices into different subsets and corresponding energy states for the different subsets of devices can be identified through application of the energy consumption model.

The technology described herein can be applied in an agnostic manner. Specifically, the models described herein can be trained and applied in an agnostic manner. Agnostic, as used herein, can include applying the techniques described herein in a manner that is one or a combination of data-agnostic, sensor-agnostic, device-agnostic, platform-agnostic, and cloud agnostic. In being applied in a platform-agnostic manner, the models can be trained and run irrespective of underlying operating systems and processor architectures utilized in supporting the models. In being applied in a cloud-agnostic manner, the models can be trained and run irrespective of an underlying cloud system utilized in supporting the models.

In applying the technology in a data-agnostic manner, applicable data that is related to a device operating by consuming energy to affect an environment, e.g. an enclosed environment, can be used in implementing the technology described herein. Specifically, data can be integrated with the technology described herein regardless of a form or source of the date. For example, a forklift can be seamlessly onboarded irrespective of whether the system is aware of or has been exposed to data used in operating the forklift. Data-agnostic operation is advantageous as it facilitates implementation of the technology, at least in part, in a device-agnostic and sensor-agnostic manner.

In applying the technology in a sensor-agnostic manner, the technology can be applied irrespective of sensor location, sensor type, or other characteristics of sensors that generate the data for training and implementing the models. For example, data can be used to train and apply different models regardless of the types of sensors that are used in generating data related to energy consumption of devices in an environment and environmental state in the environment. In another example, data can be used to train and apply different models regardless of the types of sensors that are used in generating data that characterizes operational constraints and device settings related to operation of devices in an environment.

Sensors can be clustered in a sensor-agnostic manner. As follows, data generated by the clustered sensors can be applied in a sensor-agnostic manner to implement the technology described herein. In clustering sensors in a sensor-agnostic manner, the sensors can be clustered in an unsupervised manner, e.g. regardless of sensor location, sensor type, or other characteristics of the sensors. More specifically, sensors can be clustered in a sensor-agnostic manner as long as the sensors generated data related to devices that in operating to consume energy affect an environmental state in an environment. For example, sensors that generate data related to operation of lights and forklifts in a warehouse can be clustered together. As follows, the data generated by such sensors can be used in training and implementing models for predicting energy consumption of the lights and the forklifts in the warehouse based on affected environmental state.

In applying the technology in a device-agnostic manner, the technology can be applied irrespective of device location, device type, or other characteristics of devices for which energy consumption is predicted based on affected environmental state. In particular, different devices and groups of devices can be modeled based on the same environmental state or states. As follows, the models can be applied to predict affected environmental states and corresponding energy consumption across the different devices.

Devices can be clustered in a device-agnostic manner. As follows, energy consumption can be predicted for the clustered devices based on the grouping of the devices in the device-agnostic manner. In clustering devices in a device-agnostic manner, the devices can be grouped without applicable external data describing characteristics of devices for grouping devices, such as external schema mappings. For example, devices in a warehouse can be grouped together irrespective of the location of the devices in the warehouse. In another example, device sin a warehouse can be grouped together irrespective of times at which the devices typically operate.

Further, the models described herein can be iteratively updated. Specifically, the models can be updated as new data for training either or both the environmental state model and the energy consumption model is available. For example, the models can be iteratively updated based on new data that is generated as current devices continue to operate in the environment. In another example, the models can be iteratively updated based on new data that is generated as new devices are added to and operated in the environment. This can allow for the models to mature so that the predictions will improve over a period of time. In particular, when multiple regression models are used in a single model, each regression model can have different frequencies and policy updates based on corresponding maturity levels of the regression models and the new data.

The techniques described herein can be applied with reference to a specific time frame. Specifically, the method shown in FIG. 3 can be applied to predict an energy state for a device in a specific time frame of operating in an environment. For example, a user can select a timeframe of during a winter day. As follows, the method can be applied to predict an energy state of a device operating on the winter day. This is advantageous as it allows for flexibility in predicting energy states of devices. Specifically, environmental conditions that affect environmental states and the meeting of operational constraints vary during the year. Therefore, the ability to predict energy states for different times in the year is advantageous as it allows for flexibility in accounting for environmental condition variability in accurately predicting energy consumption for devices.

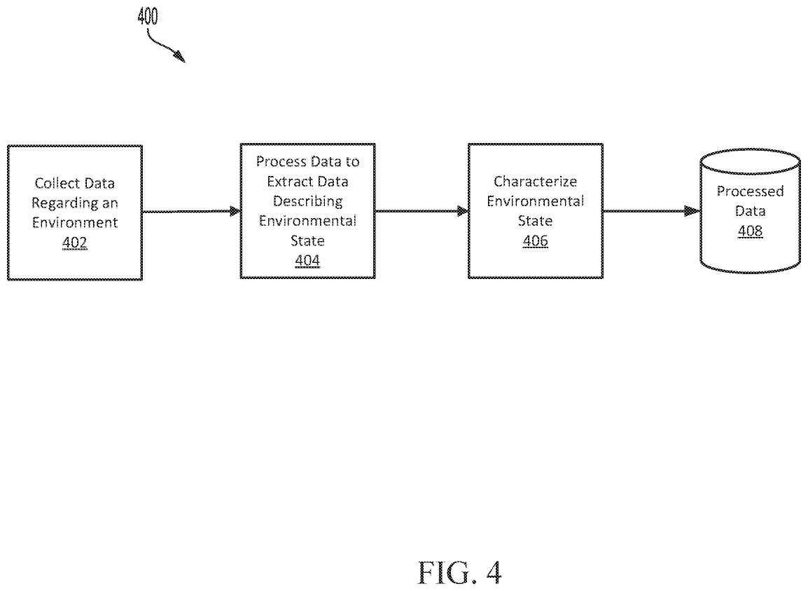

FIG. 4 is a schematic representation of a flow 400 for processing data to identify characterize an environmental state in an environment. The flow 400 can be applied according to the techniques described herein for training an environmental state model and an energy consumption model. Further, the flow 400 can be applied for purposes of predicting an energy state of a device based on environmental states according to the techniques described herein.

At operation 402, raw data regarding an operational environment for devices is collected. The raw data can include applicable data characterizing an environment and devices operating in the environment, such as the historical data described herein. Specifically, the raw data can include data describing characteristics of a device operating in the environment. For example, the raw data can include identifications of device settings of devices and operational constrains under which devices are operating in the environment. In another example, the raw data can include energy consumption characteristics of devices operating in the environment. Further, the raw data can include data describing characteristics of an environment itself. Specifically, the raw data can include data describing values of environmental variables that are affected by operation of devices in the environment. The raw data can be collected by an applicable source, such as sensors deployed in the environment.

At operation 404, the collected data is processed to extract data describing an environmental state in the environment. Specifically, the collected data can be subjected to multiple stages of cleaning and preprocessing before the environmental state is extracted. These stages can include feature extraction/selection, missing values imputation/filtering, outlier detection/filtering, multi-collinearity detection/handling of feature, and aggregation of selected features with proper statistical means. These features can include applicable features related to operation of a device in the environment and characteristics of the environment.

At operation 406, an environmental state in the environment is characterized. Specifically, and as will be discussed in greater detail later, the environmental state can be characterized by identifying environmental variables that are affected and not affected by operation of devices in the environment. More specifically, based on the values of the environmental variables that are affected and not affected in the environment, the environmental state of the environment can be characterized. As follows, the processed data indicating the characterized environmental state is stored in processed data store 408. This characterized environmental state can be used in training either or both an environmental state model and an energy consumption model.

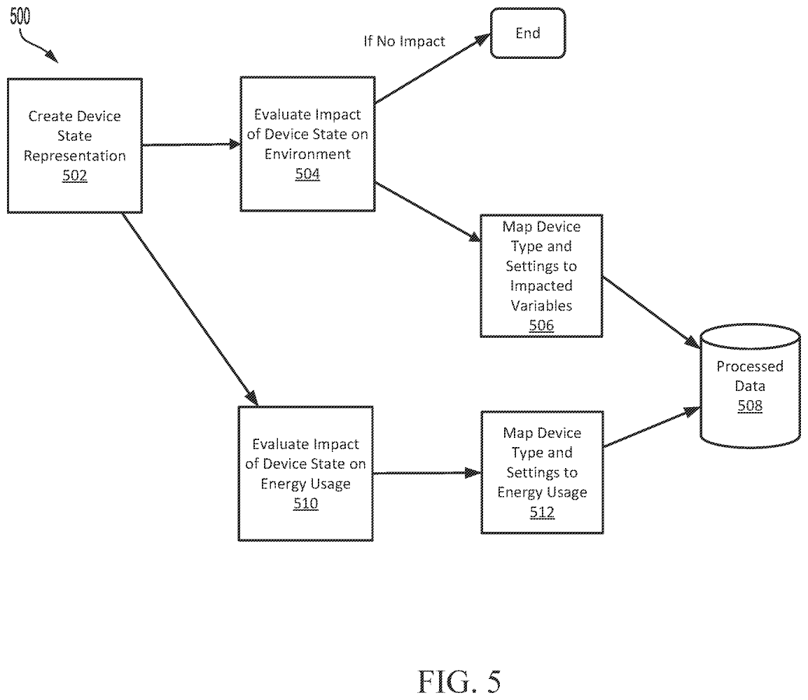

FIG. 5 is a schematic representation of a flow 500 for evaluating device impact on both an environmental state and energy consumption for mapping user settings to environmental state and energy state. The flow 500 can be applied according to the techniques described herein for training an environmental state model and an energy consumption model. Specifically, an environmental state and an energy state that are identified through the flow 500 can be mapped to each other and used in training an energy consumption model. Further, the flow 500 can be applied for purposes of predicting an energy state of a device based on environmental states according to the techniques described herein.

At operation 502, a device state representation is created. A device state representation can include a state of a device operating in an environment to meet one or more operational constraints. Specifically, a device state representation can include device settings implemented at a device operating in an environment to meet one or more operational constraints. Further, the device state representation can include applicable identification information of the device, such as the device type of the device. The device state representation can be identified from applicable data describing operation of a device in an environment, such as the historical data described herein.

At operation 504, the device state representation is evaluated to determine an impact of the device state on an environment in which the device is operating. Specifically, an impact of the device state representation can be analyzed based on environmental characteristics data that is gathered for the environment and corresponds to the device when operating according to the device state representation. Specifically, environmental variables that are affected by operation of the device in the environment at the device state representation can be analyzed to evaluate an impact of the device state on the environment. The variables that are affected by operation of the device in the environment at the device state can be identified from sensors, e.g. environmental sensors disposed in the environment.

If the device state does not have an impact on the environment, then this portion of the flow 500 with respect to analyzing device state impact on the environment ends. If the device state does have an impact on the environment, then, at operation 506, the device type and the user settings associated with the device state representation are mapped to the impacted variables. Specifically and as will be discussed in greater detail later, the device settings and operational constraints associated with the device state can be mapped to the impacted variables. More specifically and as will be discussed in greater detail later, the device settings and the operational constraints associated with the device state can be mapped to an environmental state that is characterized, at least in part, by the impacted variables. As the variables that are affected by operation of the device at the device state can be identified form environmental sensors, the device state can be mapped to an environmental state based on the data gathered by the environmental sensors. For example, humidity sensors can gather data indicating a humidity in an environment in which a device is operating. As follows, a device state of the device that affects the humidity in the environment can be mapped to an environmental state that is measured, at least in part, by the humidity sensors.

The mapping of the device type and user settings to the impacted variables in the environment can be stored as processed data stored in the processed data store 508. Specifically, the mapping of the device state to an environmental state can be stored as processed data in the processed data store 508. The processed data that is stored in the processed data store 508 can be used in training an environmental state model according to the techniques described herein.

Returning back to operation 502, once the device state representation is created, the impact of the device state on energy usage of the device can be evaluated at operation 510. Specifically, the impact of the device state on energy usage can be evaluated based on energy usage characteristics of one or more devices in the environment. For example, the amount of energy consumed by the device operating at the device state in the environment can be directly monitored to evaluate the impact of the device state on energy usage.

At operation 512, the device type and the user settings associated with the device state representation are mapped to the determined energy usage/energy state. Specifically, the device settings and operational constraints associated with the device state can be mapped to the determined energy usage. The mapping of the device type and user settings to the energy consumption can be stored as processed data stored in the processed data store 508.

The processed data that is stored in the processed data store 508 can be used in training an energy consumption model according to the techniques described herein. Specifically, the environmental state and the energy state, as indicated by the mappings in the processed data store 508, can be used in generating a corresponding mapping between varying environmental states and varying energy states, e.g. as part of training an energy consumption model. More specifically, the mapping between the varying environmental states and energy states, including the environmental state and the energy state stored in the processed data store 508 can be induced through multiple regression algorithms, such as XGBoost, Random Forest, Light GBM, and Artificial Neural Networks.

TABLE 1
Energy State Data Frame

| | | | Surge | | Water- | | | fork- | light- | light- | | |
|---|---|---|---|---|---|---|---|---|---|---|---|---|
| INDEX::datetime | HVAC | Office | Protector | Warehouse | Heater | dockLeveler | dockLock | LiftCharger | ing | ingAndFan | mdf | other |
| Aug. 24, 2021 | 18.24 | 3.37 | 0.35 | 1.56 | 1.76 | 0.97 | 0.16 | 3.48 | 25.48 | 1.97 | 1.72 | 1.48 |
| 15:00 | | | | | | | | | | | | |
| Aug. 24, 2021 | 20.7 | 2.89 | 0.34 | 1.72 | 0.23 | 1.23 | 0.07 | 30.04 | 23.64 | 2.79 | 1.92 | 0.84 |
| 16.00 | | | | | | | | | | | | |
| Aug. 24, 2021 | 14.63 | 4.62 | 0.35 | 3.67 | 1.82 | 1.22 | 0.1 | 25.77 | 29.13 | 5.5 | 1.44 | 0.73 |
| 17:00 | | | | | | | | | | | | |
| Aug. 24, 2021 | 21.79 | 3.2 | 0.35 | 3.24 | 0.34 | 0.91 | 0.1 | 31.19 | 24.83 | 7.78 | 1.8 | 0.61 |
| 18:00 | | | | | | | | | | | | |
| Aug. 24, 2021 | 25.57 | 3.35 | 0.35 | 0.42 | 0.69 | 1.03 | 0.18 | 32.89 | 25.3 | 0.36 | 1.47 | 1.34 |
| 19:00 | | | | | | | | | | | | |

Table 1 shows sample energy states for an environment. As shown in Table 1, the devices are grouped according to their device types, 12 different types. With respect to mapping environmental states to energy states, the environmental state data frame can act as a common input for each regression problem and each column in the energy state, e.g. as shown in Table 1, can be considered as an output vector. With respect to the environment represented in Table 1, as there are 12 device types, there can be 12 separate regressions. Different types of hyperparameter tunings, such as random search, Bayesian optimization, and genetic search, can be performed to identify the best parameter set for each regression algorithm. Multiple different evaluation metrics, such as mean squared error, mean absolute percent error, root mean squared error and normalized root mean squared error, can be determined to estimate the efficacy of all the regression methods. Based on the prediction capabilities of each regression method for each output vector, the hybrid system can be incorporated to predict the energy state for all 12 energy-consuming device groups.

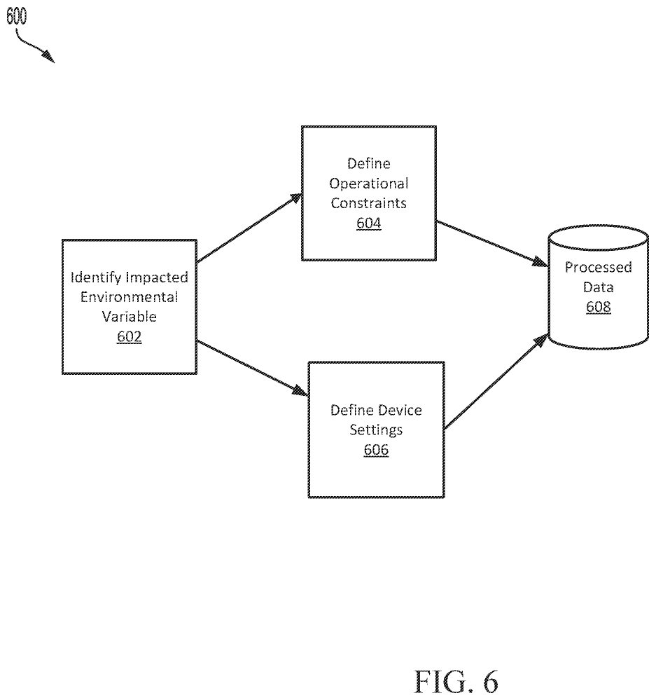

FIG. 6 is a schematic representation of a flow 600 for evaluating the effect of user settings on environmental states. The flow 600 can be applied according to the techniques described herein for training an environmental state model and an energy consumption model. Specifically, an environmental state that is mapped to user settings through the flow 600 can be used in training an environmental state model according to the techniques described herein.

At operation 602, impacted environmental variables are identified. Specifically, environmental variables in an environment that are impacted by operation of one or more devices in the environment can be determined. Environmental variables include applicable variables that define, at least in part, environmental states in the environment. As follows, by identifying the impacted environmental variables, environmental states in the environment can be identified.

At operation 604, operational constraints that affect the impacted environmental variables are defined. Specifically, operational constraints that are realized through operation of one or more devices in the environment and that affect the impacted environmental variables are defined. For example, a device can operate to provide light in a warehouse during the day. Further, by providing light during the day, the temperature in the warehouse can be raised during the day. As follows, the operational constraint of providing light in the warehouse during the day can be defined with respect to environmental state corresponding to increased temperatures in the warehouse during the day.

At operation 606, device settings that affect the impacted environmental variables are defined. Specifically, device settings that when implemented through one or more devices in the environment affect the impacted environmental variables are defined. For example, a device that operates at a specific device setting level can increase the noise in an environment. As follows, the specific device setting level can be mapped to an environmental states with the increased noise level.

Both the defined device settings and defined operational constraints can be stored as processed data in the processed data store 608. The processed data, in turn, can be used in training either or both an environmental state model and an energy consumption model. Specifically, user settings that affect certain environmental variables can be mapped to the environmental states that are defined by the affected environmental variables. In turn, this mapping can be used in training an environmental state model.

The mapping of the impacted variables, and corresponding environmental states, can be done across different environmental states and different user settings. In turn, the relationships of the user settings and the impacted variables/environmental states can be correlated across the different environmental states and different user settings. For example, a specific device setting can affect a specific environmental variable across different environmental states. In turn, the different environmental states can be correlated based on this device setting affecting the specific environmental variable across the environmental states. As follows, these correlations can be used in further mapping user settings to environmental states.

The techniques of identifying energy states for operating a device in an environment at different devices settings can be applied for selecting device settings based on energy consumption. Specifically, energy states for operating a device at different user settings, e.g. different devices settings and/or different operational constraints, can be predicted through the techniques described herein. In turn, a user setting can be selected based on the different energy states. For example, a user setting that corresponds to the lowest energy consumption or a reduced energy consumption with respect to default user settings can be selected through the techniques described herein for predicting different energy states of a device. As follows, operation of the device in the environment can be facilitated according the identified or otherwise selected user setting. For example, the selected user setting can be presented to an operator of a device who can then configure the device to operate according to the selected user setting.

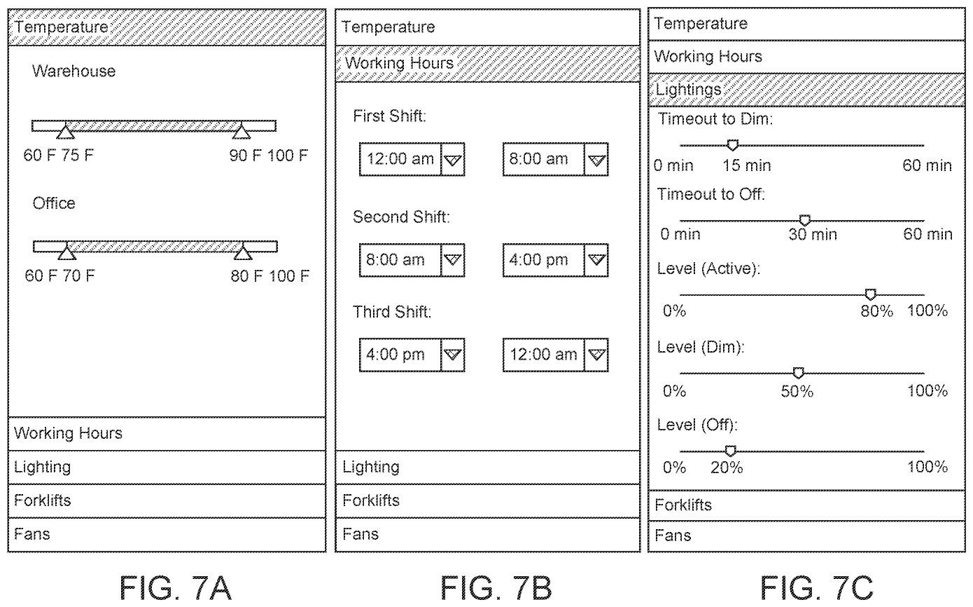

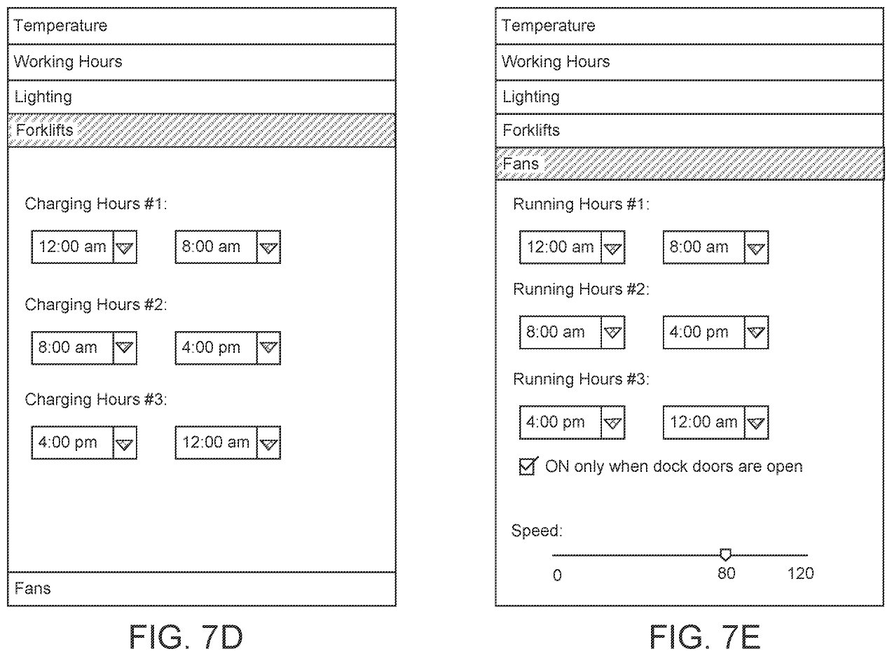

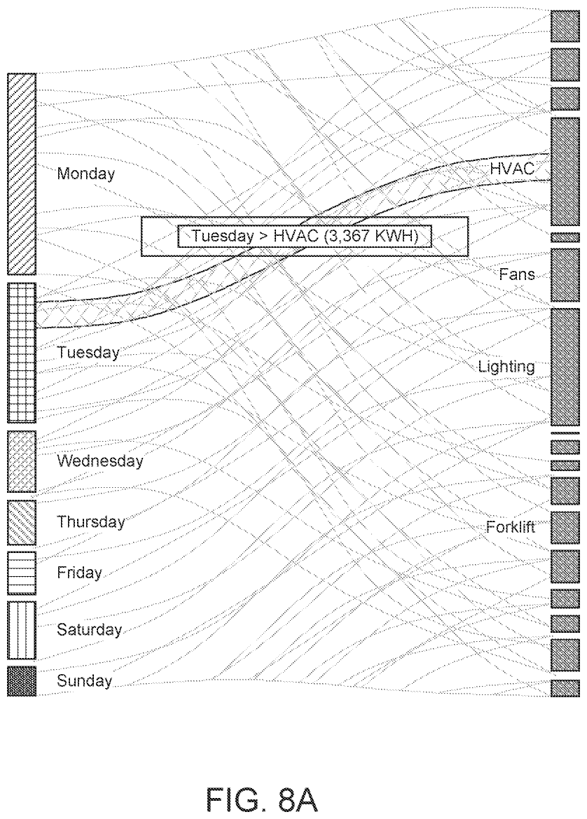

User settings can be displayed to a user as part of selecting user settings for identifying an energy state of a device for the user settings. Further, user settings can be displayed to a user as part of showing a selected user setting based on energy consumption levels. FIGS. 7A-E show examples of different displayed user settings. FIG. 7A illustrates a user interface displaying temperature ranges that serve as operational constraints. FIG. 7B illustrates a user interface displaying time intervals that serve as either or both device settings and operational constraints. FIG. 7C illustrates a user interface displaying specific settings related to operation of lights. FIG. 7D illustrates a user interface displaying charging times for charging devices in an environment. FIG. 7E illustrates a user interface displaying tunning times for running devices in an environment.

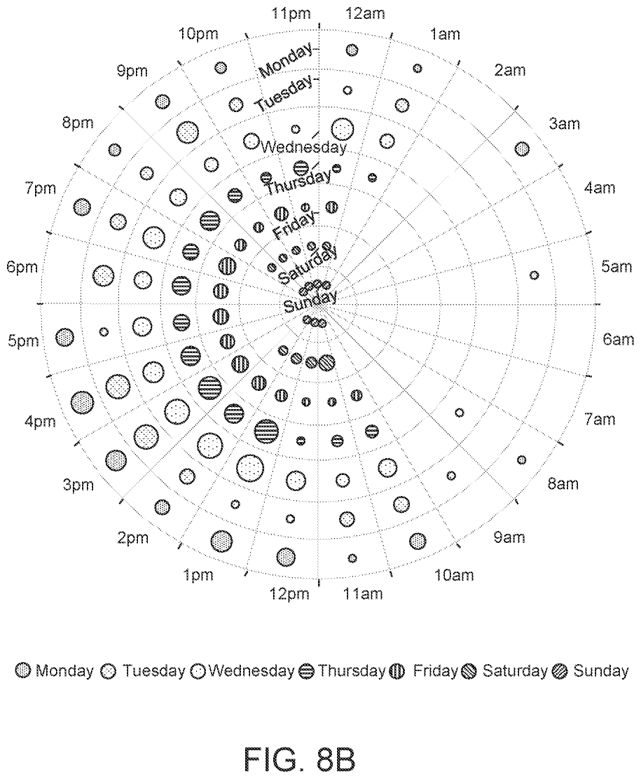

Predicted energy usage can also be displayed to users. Specifically, FIG. 8A illustrates a user interface displaying energy usage on a per-device basis. FIG. 8B illustrates a user interface displaying energy usage on different times of day.

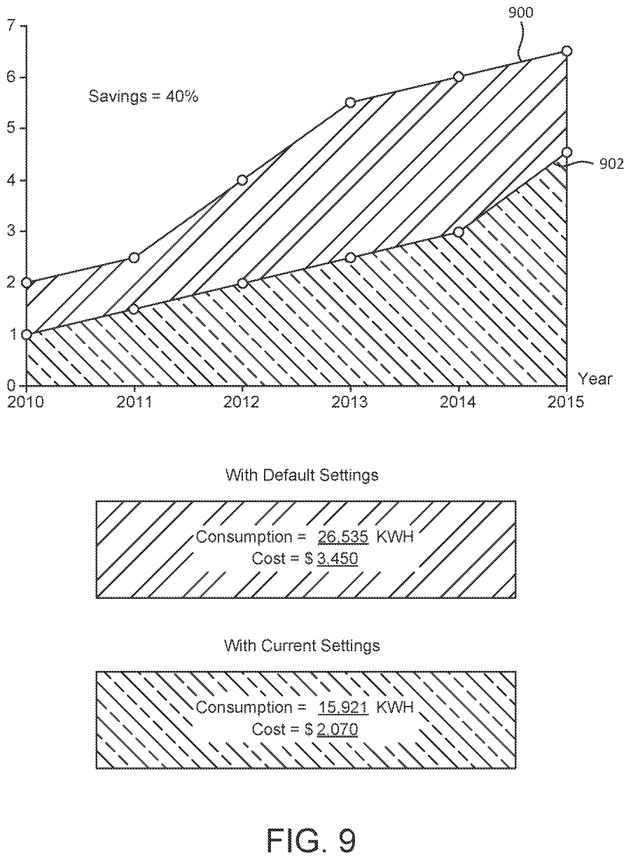

Through the techniques described herein of predicting energy usage, improvements of energy consumption can be observed for a given environment. Specifically, FIG. 9 shows a graph of energy consumption over time for default user settings 900 and energy consumption over time for predicted user settings 902. As shown, the energy consumption for the predicted user settings is much less over time than the energy consumption for the default user settings. More specifically, the default user settings corresponds to an energy consumption of 26,535 kWh at a cost of $3,450. Meanwhile, the predicted user settings corresponds to an energy consumption of 15,921 kWh at a cost of $2,070.

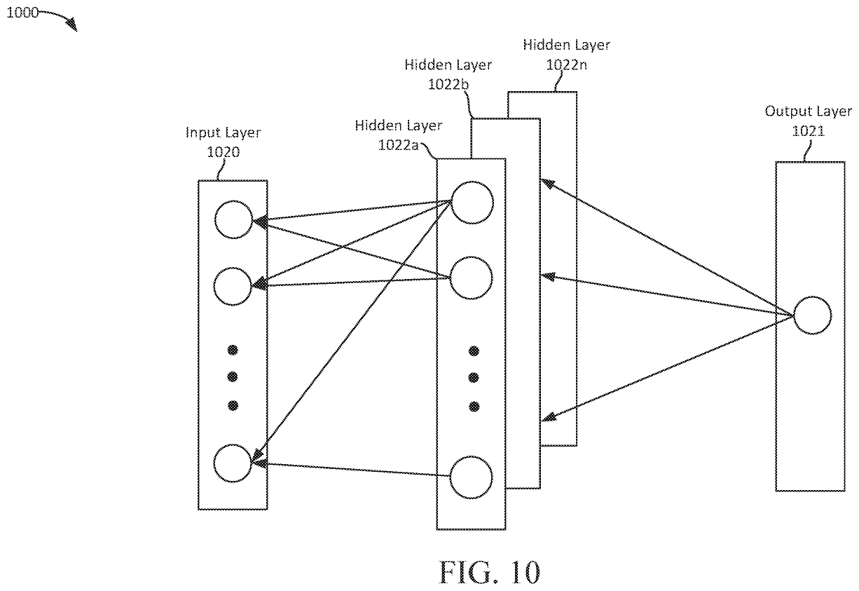

In FIG. 10, the disclosure now turns to a further discussion of models that can be used through the environments and techniques described herein. FIG. 10 is an example of a deep learning neural network 1000 that can be used to implement all or a portion of the systems and techniques described herein. An input layer 1020 can be configured to receive sensor data and/or data relating to an environment. The neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network 1000 further includes an output layer 1021 that provides an output resulting from the processing performed by the hidden layers 1022a, 1022b, through 1022n.

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the first hidden layer 1022a can transform the information of each input node by applying activation functions to the input node information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1021, at which an output is provided. In some cases, while nodes in the neural network 1000 are shown as having multiple output lines, a node can have a single output and all lines shown as being output from a node represent the same output value.

In some cases, each node or interconnection between nodes can have a weight that is a set of parameters derived from the training of the neural network 1000. Once the neural network 1000 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1021.

In some cases, the neural network 1000 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1000 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ( 1/2 (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1000 can perform a backward pass by determining which inputs (weights) most contributed to the loss of the network, and can adjust the weights so that the loss decreases and is eventually minimized.

The neural network 1000 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 1000 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

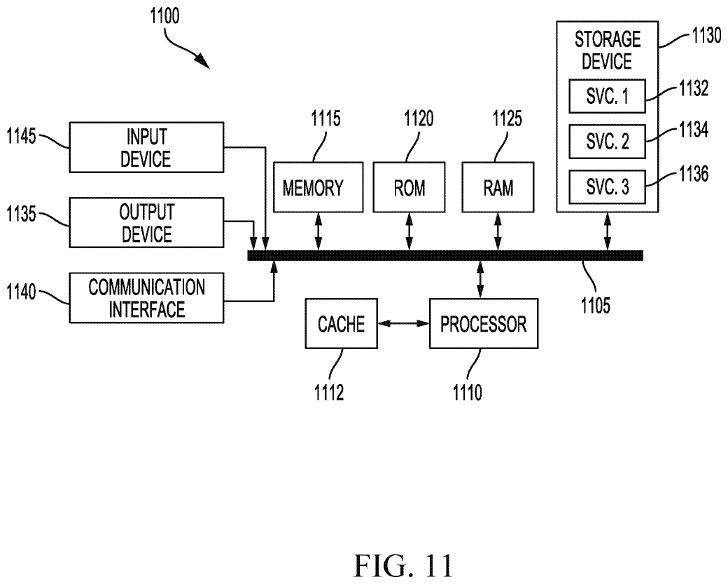

FIG. 11 illustrates an example computing device architecture 1100 which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 11 illustrates an example computing device architecture 1100 of a computing device which can implement the various technologies and techniques described herein. The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM) 1120 and random access memory (RAM) 1125, to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general purpose processor and a hardware or software service, such as service 1 1132, service 2 1134, and service 3 1136 stored in storage device 1130, configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art, such as a display, projector, television, speaker device, etc. In some instances, multimodal computing devices can enable a user to provide multiple types of input to communicate with the computing device architecture 1100. The communications interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include services 1132, 1134, 1136 for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1. A method comprising: identifying an operational constraint for a device in an environment; selecting a device setting for the device operating in the environment; predicting an environmental state of the environment based on the device operating at the device setting and under the operational constraint through application of an environmental state model that maps varying operational constraints and varying device settings to varying environmental states in the environment; and predicting an energy state for operating the device in the environment at the device setting and under the operational constraint based on the predicted environmental state through application of an energy consumption model that maps the varying environmental states to varying energy states.

Statement 2. The method of statement 1, further comprising: predicting different energy states for operating the device at different device settings in the environment and under the operational constraint; selecting a device setting of the different device settings for operating the device under the specific operational constraint based on the different energy states; and facilitating operation of the device in the environment according to the device setting.

Statement 3. The method of any of statements 1 and 2, wherein operation of the device in the environment affects the varying environmental states in the environment.

Statement 4. The method of any of statements 1 through 3, wherein the environment is an enclosed space.

Statement 5. The method of any of statements 1 through 4, wherein the environmental state model is trained across the varying device settings and the varying operational constraints based on historical data related to one or more devices operating in the environment, the method further comprising: defining a specific device state of a plurality of device states for the one or more devices operating in the environment from the historical data according to either or both a specific device setting of the varying device settings and a specific operational constraint of the varying operational constraints; mapping a specific environmental state of the varying environmental states in the environment to the specific device state based on environmental sensor data included in the historical data; and training the environmental state model based on the mapping of the specific environmental state to the specific device state of the plurality of device states.

Statement 6. The method of any of statements 1 through 5, wherein mapping the specific environmental state to the specific device state further comprises: identifying one or more environmental characteristics of the environment that are affected by operation of the one or more devices in the environment at the specific device state from the environmental sensor data included in the historical data; and identifying the specific environmental state corresponds to the specific device state based on the one or more environmental characteristics.

Statement 7. The method of any of statements 1 through 6, wherein the one or more environmental characteristics are related to the specific environmental state in a correlation of the varying environmental states across a plurality of environmental characteristics that are affected by the varying operational constraints and the varying device settings, the method further comprising: identifying the specific environmental state based on a relation of the one or more environmental characteristics to the specific environmental state in the correlation of the varying environmental states across the plurality of environmental characteristics including the one or more environmental characteristics.

Statement 8. The method of any of statements 1 through 7, wherein either or both the environmental state model and the energy consumption model are trained and implemented based on the historical data in an agnostic manner.

Statement 9. The method of any of statements 1 through 8, wherein the energy consumption model maps the varying environmental states to varying energy states through multiple regression techniques.

Statement 10. The method of any of statements 1 through 9, wherein the energy state is identified for the device on one of a device-specific basis, a device-zone specific basis, or a device-group specific basis.

Statement 11. The method of any of statements 1 through 10, further comprising: identifying an operational constraint for another device in the environment;, wherein the another device is separate from the device, in a different zone from the device, or in a different group from the device; selecting a device setting for the another device in the environment; predicting the environmental state of the environment based on the another device operating at the device setting for the another device and under the operational constraint for the another device through application of the environmental state model; and predicting an energy state for operating the another device in the environment at the device setting for the another device and under the operational constraint for the another device through application of the energy consumption model independently from applying the energy consumption model to predict the energy state for operating the device in the environment.

Statement 12. The method of any of statements 1 through 11, further comprising: iteratively updating either or both the environmental state model and the energy consumption model based on new data gathered in the environment.

Statement 13. The method of any of statements 1 through 12, wherein the new data is generated based on continued operation of the device of a plurality of devices in the environment.

Statement 14. The method of any of statements 1 through 13, wherein the new data is generated based on operation of new devices added to the environment.

Statement 15. A system comprising: one or more processors; and at least one computer-readable storage medium having stored therein instructions which, when executed by the one or more processors, cause the one or more processors to: identify an operational constraint for a device in an environment; select a device setting for the device operating in the environment; predict an environmental state of the environment based on the device operating at the device setting and under the operational constraint through application of an environmental state model that maps varying operational constraints and varying device settings to varying environmental states in the environment; and predict an energy state for operating the device in the environment at the device setting and under the operational constraint based on the predicted environmental state through application of an energy consumption model that maps the varying environmental states to varying energy states.

Statement 16. The system of statement 15, wherein the instructions further cause the one or more processors to: predict different energy states for operating the device at different device settings in the environment and under the operational constraint; select a device setting of the different device settings for operating the device under the specific operational constraint based on the different energy states; and facilitate operation of the device in the environment according to the device setting.

Statement 17. The system of any of statements 15 and 16, wherein the environmental state model is trained across the varying device settings and the varying operational constraints based on historical data related to one or more devices operating in the environment, and the instructions further cause the one or more processors to: defining a specific device state of a plurality of device states for the one or more devices operating in the environment from the historical data according to either or both a specific device setting of the varying device settings and a specific operational constraint of the varying operational constraints; mapping a specific environmental state of the varying environmental states in the environment to the specific device state based on environmental sensor data included in the historical data; and training the environmental state model based on the mapping of the specific environmental state to the specific device state of the plurality of device states.

Statement 18. The system of any of statements 15 through 17, wherein the instructions further cause the one or more processors to: identify one or more environmental characteristics of the environment that are affected by operation of the one or more devices in the environment at the specific device state from the environmental sensor data included in the historical data; and identify the specific environmental state corresponds to the specific device state based on the one or more environmental characteristics.

Statement 19. The system of any of statements 15 through 18, wherein either or both the environmental state model and the energy consumption model are trained and implemented based on the historical data in an agnostic manner.

Statement 20. A non-transitory computer-readable storage medium having stored therein instructions which, when executed by one or more processors, cause the one or more processors to: identify an operational constraint for a device in an environment; select a device setting for the device operating in the environment; predict an environmental state of the environment based on the device operating at the device setting and under the operational constraint through application of an environmental state model that maps varying operational constraints and varying device settings to varying environmental states in the environment; and predict an energy state for operating the device in the environment at the device setting and under the operational constraint based on the predicted environmental state through application of an energy consumption model that maps the varying environmental states to varying energy states.

Statement 21. A system comprising means for performing a method according to any of Statements 1 through 14.

What is claimed is:

1. A method comprising:
identifying an operational constraint for a device in an environment;
selecting a device setting for the device operating in the environment;
predicting an environmental state of the environment based on the device operating at the device setting and under the operational constraint through application of an environmental state model that maps varying operational constraints and varying device settings to varying environmental states in the environment; and
predicting an energy state for operating the device in the environment at the device setting and under the operational constraint based on the predicted environmental state through application of an energy consumption model that maps the varying environmental states to varying energy states.

2. The method of claim 1, further comprising:
predicting different energy states for operating the device at different device settings in the environment and under the operational constraint;
selecting a device setting of the different device settings for operating the device under the operational constraint based on the different energy states; and
facilitating operation of the device in the environment according to the device setting.

3. The method of claim 1, wherein operation of the device in the environment affects the varying environmental states in the environment.

4. The method of claim 3, wherein the environment is an enclosed space.

5. The method of claim 1, wherein the environmental state model is trained across the varying device settings and the varying operational constraints based on historical data related to one or more devices operating in the environment, the method further comprising:
defining a specific device state of a plurality of device states for the one or more devices operating in the environment from the historical data according to either or both a specific device setting of the varying device settings and a specific operational constraint of the varying operational constraints;
mapping a specific environmental state of the varying environmental states in the environment to the specific device state based on environmental sensor data included in the historical data; and
training the environmental state model based on the mapping of the specific environmental state to the specific device state of the plurality of device states.

6. The method of claim 5, wherein mapping the specific environmental state to the specific device state further comprises:
identifying one or more environmental characteristics of the environment that are affected by operation of the one or more devices in the environment at the specific device state from the environmental sensor data included in the historical data; and
identifying the specific environmental state corresponds to the specific device state based on the one or more environmental characteristics.

7. The method of claim 6, wherein the one or more environmental characteristics are related to the specific environmental state in a correlation of the varying environmental states across a plurality of environmental characteristics that are affected by the varying operational constraints and the varying device settings, the method further comprising:
identifying the specific environmental state based on a relation of the one or more environmental characteristics to the specific environmental state in the correlation of the varying environmental states across the plurality of environmental characteristics including the one or more environmental characteristics.

8. The method of claim 5, wherein either or both the environmental state model and the energy consumption model are trained and implemented based on the historical data in an agnostic manner.

9. The method of claim 1, wherein the energy consumption model maps the varying environmental states to varying energy states through multiple regression techniques.

10. The method of claim 1, wherein the energy state is identified for the device on one of a device-specific basis, a device-zone specific basis, or a device-group specific basis.

11. The method of claim 10, further comprising:
identifying an operational constraint for another device in the environment;, wherein the another device is separate from the device, in a different zone from the device, or in a different group from the device;
selecting a device setting for the another device in the environment;
predicting the environmental state of the environment based on the another device operating at the device setting for the another device and under the operational constraint for the another device through application of the environmental state model; and
predicting an energy state for operating the another device in the environment at the device setting for the another device and under the operational constraint for the another device through application of the energy consumption model independently from applying the energy consumption model to predict the energy state for operating the device in the environment.

12. The method of claim 1, further comprising:
iteratively updating either or both the environmental state model and the energy consumption model based on new data gathered in the environment.

13. The method of claim 12, wherein the new data is generated based on continued operation of the device of a plurality of devices in the environment.

14. The method of claim 12, wherein the new data is generated based on operation of new devices added to the environment.

15. A system comprising:
one or more processors; and
at least one computer-readable storage medium having stored therein instructions which, when executed by the one or more processors, cause the one or more processors to:
identify an operational constraint for a device in an environment;
select a device setting for the device operating in the environment;
predict an environmental state of the environment based on the device operating at the device setting and under the operational constraint through application of an environmental state model that maps varying operational constraints and varying device settings to varying environmental states in the environment; and
predict an energy state for operating the device in the environment at the device setting and under the operational constraint based on the predicted environmental state through application of an energy consumption model that maps the varying environmental states to varying energy states.

16. The system of claim 15, wherein the instructions further cause the one or more processors to:
predict different energy states for operating the device at different device settings in the environment and under the operational constraint;
select a device setting of the different device settings for operating the device under the operational constraint based on the different energy states; and
facilitate operation of the device in the environment according to the device setting.

17. The system of claim 15, wherein the environmental state model is trained across the varying device settings and the varying operational constraints based on historical data related to one or more devices operating in the environment, and the instructions further cause the one or more processors to:
defining a specific device state of a plurality of device states for the one or more devices operating in the environment from the historical data according to either or both a specific device setting of the varying device settings and a specific operational constraint of the varying operational constraints;
mapping a specific environmental state of the varying environmental states in the environment to the specific device state based on environmental sensor data included in the historical data; and
training the environmental state model based on the mapping of the specific environmental state to the specific device state of the plurality of device states.

18. The system of claim 17, wherein the instructions further cause the one or more processors to:
identify one or more environmental characteristics of the environment that are affected by operation of the one or more devices in the environment at the specific device state from the environmental sensor data included in the historical data; and
identify the specific environmental state corresponds to the specific device state based on the one or more environmental characteristics.

19. The system of claim 17, wherein either or both the environmental state model and the energy consumption model are trained and implemented based on the historical data in an agnostic manner.

20. A non-transitory computer-readable storage medium having stored therein instructions which, when executed by one or more processors, cause the one or more processors to:
identify an operational constraint for a device in an environment;
select a device setting for the device operating in the environment;
predict an environmental state of the environment based on the device operating at the device setting and under the operational constraint through application of an environmental state model that maps varying operational constraints and varying device settings to varying environmental states in the environment; and
predict an energy state for operating the device in the environment at the device setting and under the operational constraint based on the predicted environmental state through application of an energy consumption model that maps the varying environmental states to varying energy states.
